(19) United States
(12) Patent Application Publication
(10) Pub. No.: US 2003/0115377 A1
(43) Pub. Date: Jun. 19, 2003

(54) Systems and methods for providing a customer relationship management architecture

(75) Inventors: Lewis Curtis, Smyrna, GA (US); John Crupi, Bethesda, MD (US)

Correspondence Address: Finnegan, Henderson, Farabow,, Garrett & Dunner, L.L.P., 1300 I Street, N.W., Washington, DC, 20005-3315, US

(73) Assignee: Sun Microsystems, Inc.

(21) Appl. No.: 10/021,084

(22) Filed: Dec. 19, 2001

(51) Int. Cl. G06F 9/00

(52) U.S. Cl. 709/328; 705/1

(57) ABSTRACT

A method and system for providing an integrated, enterprise-wide customer relationship management architecture comprises separating services provided by the customer relationship management architecture into tiers, separating hardware and software that host services provided by the customer relationship management architecture into layers, and maintaining systemic qualities in each of the tiers and in each of the layers.

### TECHNICAL FIELD

The present invention relates to the field of customer relationship management. More particularly, the present invention, in various specific embodiments, involves methods and systems directed to providing a customer relationship management architecture.

### BACKGROUND

The need to provide an integrated, enterprise-wide customer relationship management architecture has become a common need for many organizations. Recent economic changes have altered the rules of customer relationship management, yet most legacy customer relationship management solutions do not readily adapt to change. These changes have been fueled, at least in part, by the “Internet effect”. The “Internet effect” is a phenomenon characterized by an explosive and near simultaneous growth of network computing such as the number of users, the diversity of devices, the amount of bandwidth, the transaction volume, the quantity of network services, and the volume of data. Each of these elements is growing at a tremendous rate. When combined into a single growth measurement of network computing, the result is exponential growth.

The “Internet effect” also creates an upward spiral in the value of a computer network because the more powerful the network becomes, the more it is used, and the more it is used the more important the network becomes as a business tool. Further, the “Internet effect” creates a dramatic increase in consumer power because it makes the network a focal point for competitive differentiation.

Traditional customer relationship management solutions focused on improving an enterprise's operational efficiencies specifically regarding its customer relationships. The dramatic growth in Internet commerce and communication has created new market realities and new technical requirements that legacy customer relationship management solutions simply were not designed to address. While Internet enablement of legacy systems achieves the short-term objective of making diverse systems available over the Internet, the resulting Internet presence is fractured and difficult for customers to navigate. In addition, this approach makes it extremely difficult to combine the functionality of various databases and to create new value-added services. Moreover, Internet enablement of a client-server model does little to change the inflexibility of the underlying client-server architecture.

Thus, traditional customer relationship management solutions were not aimed at creating an integrated, enterprise-wide view of the customer, therefore the technical architecture of traditional customer relationship management solutions focused on linking islands of customer data and business processes. Typically, historical customer relationship management solution vendors built their solutions based on a two-tiered client-server model. The advent of the Internet and new customer requirements, however, soon exposed the flaws of traditional customer relationship management solutions. Therefore, there remains a need for an integrated, enterprise-wide customer relationship management architecture. More particularly, there is a need to implement a more agile, Internet enabled customer relationship management architecture that delivers on a new set of customer requirements while meeting increasingly stringent business objectives.

### SUMMARY OF THE INVENTION

In accordance with the current invention, a customer relationship management architecture method and system are provided that avoid the problems associated with prior art customer relationship management systems as discussed herein above.

In one aspect, a method for providing an integrated, enterprise-wide customer relationship management architecture comprises separating services provided by the customer relationship management architecture into tiers, separating hardware and software that host services provided by the customer relationship management architecture into layers, and maintaining systemic qualities in each of the tiers and in each of the layers.

In another aspect, an integrated, enterprise-wide customer relationship management architecture system comprises tiers associated with services provided by the customer relationship management architecture, layers associated with hardware and software that host services provided by the customer relationship management architecture, and systemic qualities which are maintained in each of the tiers and in each of the layers. The tiers, layers, and systemic qualities have an orthogonal relationship.

In yet another aspect, a method for providing an integrated, enterprise-wide customer relationship management architecture comprises separating services provided by the customer relationship management architecture into tiers, separating hardware and software that host services provided by the customer relationship management architecture into layers, and maintaining systemic qualities in each of the tiers and in each of the layers. The method also comprises relating the tiers, layers, and systemic qualities orthogonally wherein each of the systemic qualities is being provided in at least one of the tiers, each of the tiers having different optimal choices of implementations in at least one of the layers, and each of the layers enabling different strategies associated with at least one of the tiers.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a diagram relating various aspects of a system for providing a customer relationship management architecture consistent with the present invention;

FIG. 2 is a flow chart of a method for providing a customer relationship management architecture consistent with the present invention;

FIG. 3 is a flow chart of a subroutine used in the method of FIG. 2 for separating services provided by the customer relationship management architecture into tiers consistent with the present invention.

FIG. 4 is a flow chart of a subroutine used in the method of FIG. 2 for separating hardware and software that host services provided by the customer relationship management architecture into layers consistent with the present invention; and

FIG. 5 is a flow chart of a subroutine used in the method of FIG. 2 for maintaining systemic qualities in each of the tiers and in each of the layers consistent with the present invention.

### DETAILED DESCRIPTION

Reference will now be made to various embodiments according to this invention, examples of which are shown in the accompanying drawings and will be obvious from the description of the invention. In the drawings, the same reference numbers represent the same or similar elements in the different drawings whenever possible.

Customer Relationship Management Architecture System

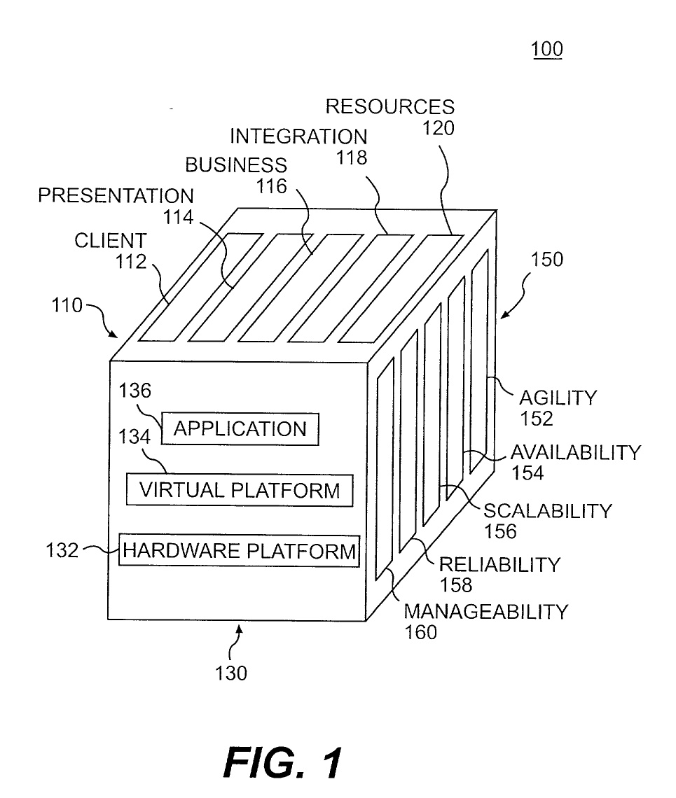

Referring to FIG. 1, an embodiment consistent with the present invention provides systems and methods for providing a customer relationship management architecture. There are three “dimensions” addressed in building a customer relationship management architecture 100 as illustrated by the cube of FIG. 1. The first dimension is referred to as tiers 110 comprising a client services tier 112, a presentation services tier 114, a business services tier 116, an integration services tier 118, and a resources services tier 120. The second dimension is referred to as layers 130 comprising a hardware platform layer 132, a virtual platform layer 134, and an application layer 136. And the third dimension is referred to as systemic qualities 150 comprising an agility systemic quality 152, an availability systemic quality 154, a scalability systemic quality 156, a reliability systemic quality 158, and a manageability systemic quality 160. Those skilled in the art will appreciate that tiers 110, layers 130, and systemic qualities 150 may be divided into elements other than those listed herein above. Those skilled in the art will also appreciate that customer relationship management architecture 100 may include dimensions other than those discussed above and may include more or less than three dimensions. Similarly, the individual dimensions of customer relationship management architecture 100 may be separated differently than illustrated above.

These three dimensions, comprising tiers 110, layers 130, and systemic qualities 150, may have a substantially orthogonal relationship. For example, each of the systemic qualities 150 may be provided in at least one of the tiers 110, each of the tiers 110 may have different optimal choices of implementation in at least one of the layers 130; and each of the layers 130 may enable different strategies associated with at least one of the tiers 110. By dimensioning customer relationship management architecture 100 in the aforementioned way, tiers 110, layers 130, and systemic qualities 150 define a design space onto which specific products, tools, and application components can be mapped, and against which the completeness of the overall systems architecture can be gauged.

For example, customer relationship management architecture 100 may at least enable the segregation of business logic from the presentation and data functions, and may at least enable an enterprise to propagate changes in business rules immediately throughout the enterprise. Because business logic remains independent of access channels and resource implementations, the enterprise gains the flexibility to combine different access channels (for example, e-mail, interactive voice response systems (IVRS), or web pages) and back-end resource technologies. With application logic residing on separate servers, an enterprise can vertically or horizontally scale the architecture to support growing numbers of users and higher volumes of traffic. Another attribute of the customer relationship management architecture 100 is improved response times for accessing data, for example, via the Internet. In addition, the customer relationship management architecture 100 allows developers and programmers to spend more time focusing on solving business problems rather than technical issues.

As stated previously, traditional customer relationship management architectures used proprietary designs running on specific platforms with specific numbers of processors and nodes. As technical requirements changed, enterprises often had to purchase newer versions of the system or a completely different system. In order to address the problem, the implementation of customer relationship management architecture 100 consistent with the present invention may utilize Java 2 Enterprise Edition (J2EE) marketed by Sun Microsystems of Palo Alto, Calif. Specifically, J2EE may be utilized to separate services provided by customer relationship management architecture 100 into tiers 110 by implementing the concept of container and contracts. The container can be characterized as a “virtual pegboard” into which a particular type of component can be integrated. Within J2EE, there are several types of containers, each operating in one of tiers 110.

For example, J2EE defines the Enterprise Java Bean (EJB) container, into which Enterprise Java Beans plug, and the Web container, into which Servlets and Java Server Pages plug. The “plugs” are actually APIs that the component must implement. These APIs form the Component Contract between the component and its container. The container must expose the services of the component to its clients via a set of APIs, so that the client can plug into the container. Finally, the application server vendor can implement the container in accordance with the industry specification for the specific component/container type. In this manner, J2EE can provide a variety of component and container types including Enterprise Java Beans, Servlets, Java Server Pages, Applets and Application clients. Client contracts into these containers are supported by various connectivity technologies including Java Naming and Directory Interface (JNDI), Remote Method Invocation (RMI), RMI/IIOP, HOP, Java Messaging Service (JMS), Java Transaction API (JTA), Java DataBase Connectivity (JDBC), and J2EE Connectors.

Thus, within J2EE, these component types, and their containers and contracts provide multi-tier customer relationship management architectures with interchangeable components that can be supplied by an open marketplace. In turn, these containers are implemented by application server products that are also supplied on an open marketplace.

Method For Providing A Customer Relationship Management Architecture

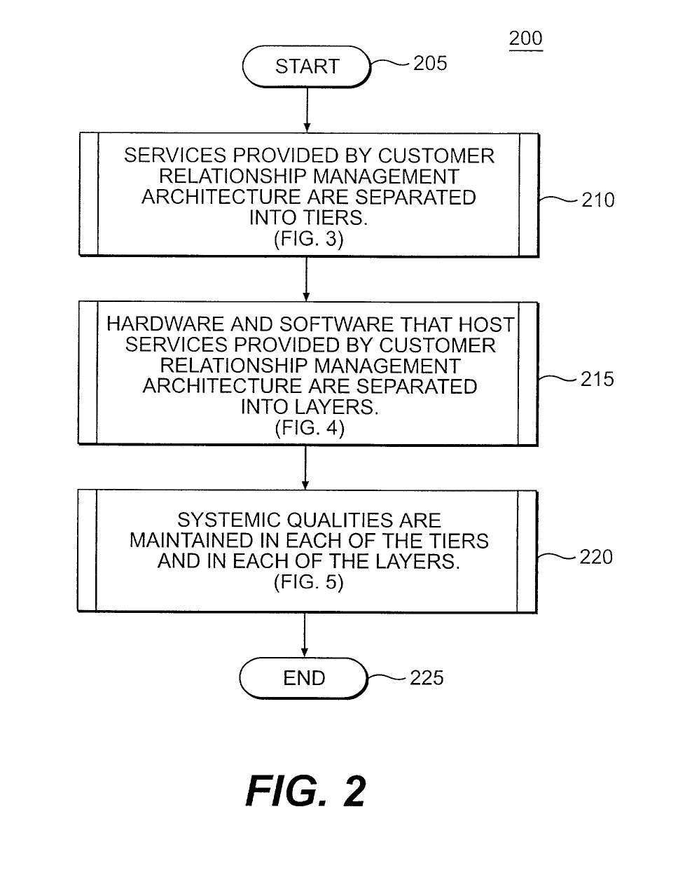

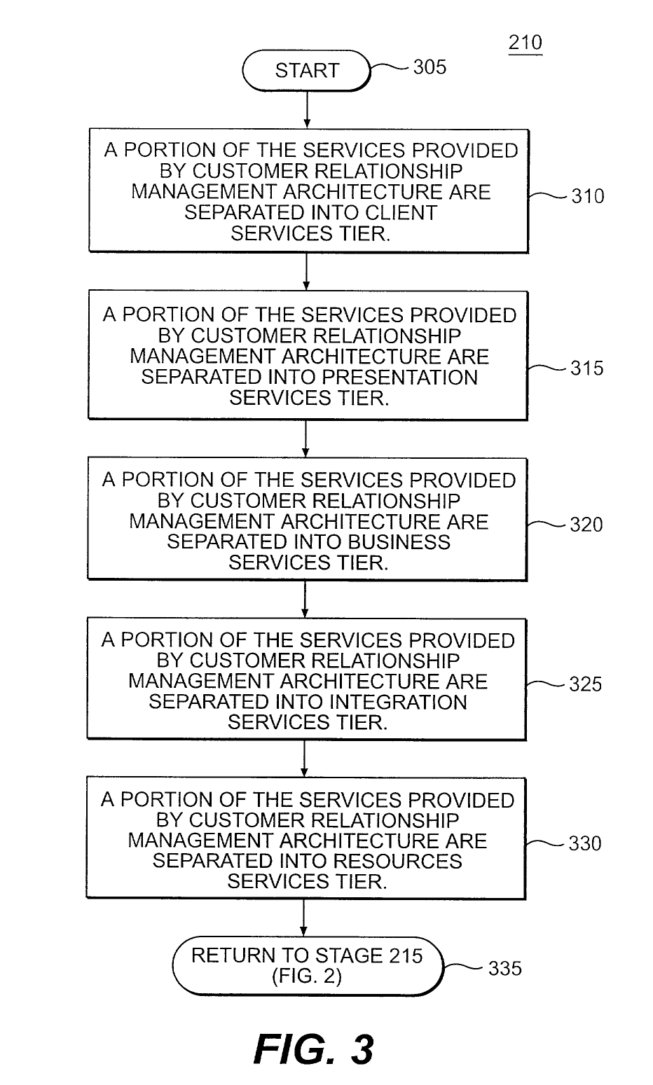

FIG. 2 is a flow chart setting forth the general stages involved in an exemplary method 200 for providing customer relationship management architecture 100. The implementation of the stages of exemplary method 200 in accordance with an exemplary embodiment of the present invention will be described in greater detail in FIG. 3 through FIG. 5.

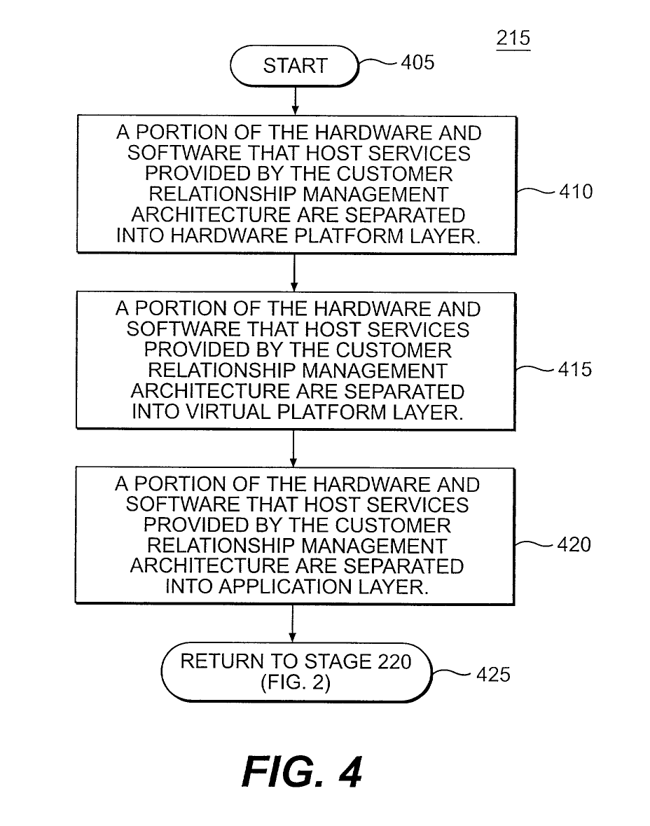

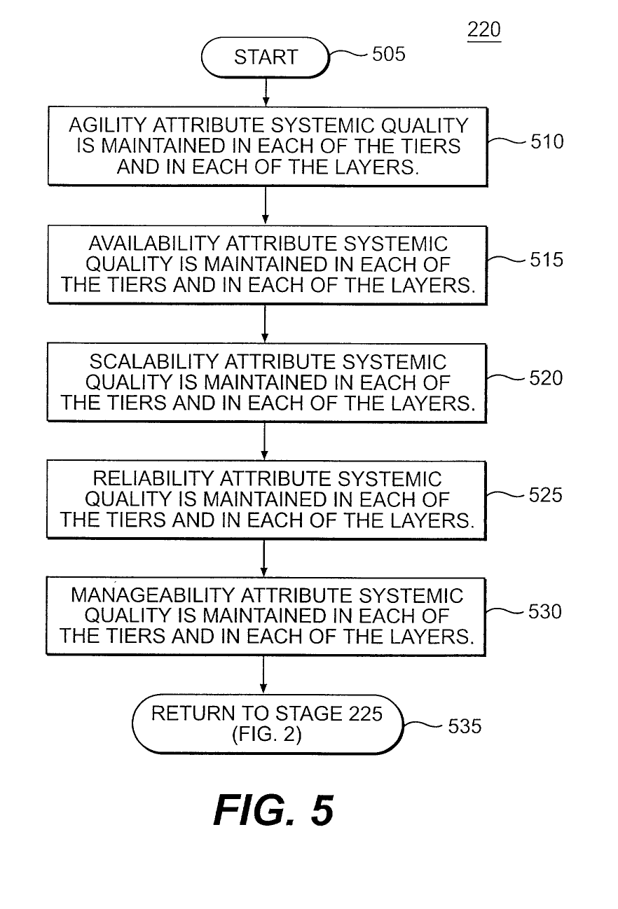

Exemplary method 200 begins at starting block 205 and proceeds to exemplary subroutine 210 where services provided by customer relationship management architecture 100 are separated into tiers 110. The stages of exemplary subroutine 210 are shown in FIG. 3 and will be described in greater detail below. From exemplary subroutine 210 where services provided by customer relationship management architecture 100 are separated into tiers 110, exemplary method 200 continues to exemplary subroutine 215 where hardware and software that host services provided by customer relationship management architecture 100 are separated into layers 130. The stages of exemplary subroutine 215 are shown in FIG. 4 and will be described in greater detail below. From exemplary subroutine 215 where hardware and software that host services provided by customer relationship management architecture 100 are separated into layers 130, exemplary method 200 continues to exemplary subroutine 220 where systemic qualities 150 are maintained in each of tiers 110 and in each of the layers 130. The stages of exemplary subroutine 220 are shown in FIG. 5 and will be described in greater detail below. From exemplary subroutine 220 where systemic qualities 150 are maintained in each of tiers 110 and in each of the layers 130, exemplary method 200 ends at stage 225.

Services Separated Into Tiers

FIG. 3 is a flow chart describing exemplary subroutine 210 from FIG. 2 in which services provided by customer relationship management architecture 100 are separated into tiers 110. Exemplary subroutine 210 begins at starting block 305 and advances to stage 310 where a portion of the services provided by customer relationship management architecture 100 are separated into client services tier 112. For example, client services that are separated into client services tier 112 may reside on the client device or system and manage local display and local interaction processing.

After a portion of the services provided by customer relationship management architecture 100 are separated into client services tier 112 in stage 310, exemplary subroutine 210 advances to stage 315 where a portion of the services provided by customer relationship management architecture 100 are separated into presentation services tier 114. For example, presentation services that are separated into presentation services tier 114 may aggregate and personalize content into channel-specific user interfaces. This may entail the assembly of content, formatting, conversion, and content transformation. Channel-specific user interfaces may include e-mail, interactive voice response systems (IVRS), or web pages. In general, presentation services relate to the presentation of information to end users or external systems.

Once a portion of the services provided by customer relationship management architecture 100 are separated into presentation services tier 114 in stage 315, exemplary subroutine 210 continues to stage 320 where a portion of the services provided by customer relationship management architecture 100 are separated into business services tier 116. For example, business services separated into business services tier 116 may execute business logic and manage transitions. Specifically, business services may include low-level services such as authentication and mail transport or true line-of-business services such as order entry, customer profile, payment, or inventory management.

From stage 320 where a portion of the services provided by customer relationship management architecture 100 are separated into business services tier 116, exemplary subroutine 210 continues to stage 325 where a portion of the services provided by customer relationship management architecture 100 are separated into integration services tier 118. For example, integration services separated into integration services tier 118 may abstract and provide access to external resources. Due to the varied and external nature of these resources, integration services tier 118 may employ loosely coupled paradigms such as queuing, publish/subscribe communications, and synchronous and asynchronous point-to-point messaging.

After a portion of the services provided by customer relationship management architecture 100 are separated into integration services tier 118 in stage 325, exemplary subroutine 210 advances to stage 330 where a portion of the services provided by customer relationship management architecture 100 are separated into resources services tier 120. For example, resources services separated into resources services tier 120 may include legacy system, databases, external data feeds, and specialized hardware devices such as publicly switched telephone systems or factory automations systems.

Once a portion of the services provided by customer relationship management architecture 100 are separated into resources services tier 120 in stage 330, exemplary subroutine 210 advances to stage 335 and returns to stage 215 of FIG. 2.

The examples of services separated into the various tiers 110 above are for illustrative purposes. Those skilled in the art will appreciate that may other types of services may be provided within customer relationship management architecture 100 and different services may be separated into the various tiers 110 as described above.

Hardware And Software Are Separated Into Layers

FIG. 4 is a flow chart describing the exemplary subroutine 215 from FIG. 2 in which hardware and software that host services provided by customer relationship management architecture 100 are separated into layers 130. Exemplary subroutine 215 begins at starting block 405 and advances to stage 410 where a portion of the hardware and software that host services provided by the customer relationship management architecture 100 are separated into hardware platform layer 132. Separating the hardware and software that host services provided by customer relationship management architecture 100 into hardware platform layer 132 at least enables, for example, separating processing components from their underlying platform implementations, giving maximum flexibility in selecting, tuning, and evolving technologies for the given architecture.

After a portion of the hardware and software that host services provided by customer relationship management architecture 100 are separated into hardware platform layer 132 in stage 410, exemplary subroutine 215 advances to stage 415 where a portion of the hardware and software that host services provided by the customer relationship management architecture 100 are separated into virtual platform layer 134. Virtual platform layer 134, for example, interposes a layer between application layer 136, as described below, and hardware platform layer 132. Virtual platform layer 134 may provide standard application program interfaces (APIs) and specifications for products such as Internet web servers, application servers, and various types of middleware.

APIs are languages and message formats used by an application program to communicate with the operating system or some other control program such as a database management system (DBMS) or communications protocol. APIs are implemented by writing function calls in the program, which provide the linkage to the required subroutine for execution. Thus, an API implies that some program module is available in the computer to perform the operation or that it must be linked into the existing program to perform the tasks. By writing applications so that they depend only on the virtual platform APIs, developers can make applications portable across upper platform products. If APIs are chosen wisely at the virtual platform level, platform independence may be a resulting benefit.

Once a portion of the hardware and software that host services provided by the customer relationship management architecture 100 are separated into virtual platform layer 134 in stage 415, exemplary subroutine 215 continues to stage 420 where a portion of the hardware and software that host services provided by the customer relationship management architecture 100 are separated into application layer 136. Similar to virtual platform layer 134, for example, if standard APIs such as enterprise resource planning (ERP) and customer relationship management (CRM) are adhere to in application layer 136, products deployed on the network, such as supply chain management or sales force automation, for example, will also be platform independent. ERP is an integrated information system that serves departments within an enterprise. Evolving out of the manufacturing industry, ERP implies the use of packaged software rather than proprietary software written by or for one customer. ERP modules may be able to interface with an enterprise's own software with varying degrees of effort, and, depending on the software, ERP modules may be alterable via the vendor's proprietary tools as well as proprietary or standard programming languages. CRM is an integrated information system that is used to plan, schedule and control the presales and postsales activities in an enterprise. Generally, CRM does not include the marketing function and could be said to be enterprise relationship management (ERM) without the marketing component. Sales force automation (SFA) evolved into CRM.

From stage 420 where a portion of the hardware and software that host services provided by the customer relationship management architecture 100 are separated into application layer 136, exemplary subroutine 215 advances to stage 425 and returns to stage 215 of FIG. 2.

The examples of hardware and software that host services that are separated into the various layers 130 above are for illustrative purposes. Those skilled in the art will appreciate that may other types of layers may be provided within customer relationship management architecture 100 and different hardware and software host services may be separated into the various layer as described above.

Systemic Qualities Are Maintained In The Tiers And In The Layers

FIG. 5 is a flow chart describing the exemplary subroutine 220 from FIG. 2 in which systemic qualities 150 are maintained in each of tiers 110 and in each of layers 130. Exemplary subroutine 220 begins at starting block 505 and advances to stage 510 where agility systemic quality 152 is maintained in each of tiers 110 and in each of layers 130. Customer relationship management architecture 100 may be configured to meet the unique needs of the enterprise in which it is implemented. Without standards, various enterprises take different approaches to customization, for example, choosing different ways to update tables or different fourth-generation language tools. J2EE, for example, can be the middle ground between a rigid packaged solution and a complete custom-built application. J2EE may enable vendors to deliver the exact functionality that a specific enterprise needs without having to construct the underlying infrastructure to support it. In addition, J2EE, for example, enables applications to be developed, updated and customized much faster and more efficiently, because the supply of J2EE developers is high compared to the number of specific vendor programming developers. Thus, agility systemic quality 152 may be maintained in each of tiers 110 and in each of layers 130 by utilizing, for example J2EE.

After agility systemic quality 152 is maintained in each of tiers 110 and in each of layers 130 in stage 510, exemplary subroutine 220 advances to stage 515 where availability systemic quality 154 is maintained in each of tiers 1 10 and in each of layers 130. Traditional customer relationship management solutions provided high availability through the hardware/operating systems layer. However, this did not always ensure high service level availability, as many other variables can impact the uptime of the application. The J2EE platform, for example, supports both stateless and stateful EJB processing environments. In a call center environment, for example, the server running in a stateless session creates an object through class instantiation, processes the specific transaction object in memory and drops the object when the transaction is completed. If the server goes down in the middle of the transaction, customer service representative may be required to restart the transaction (sometimes through re-login and re-enter of unsaved database information) and application server may be required to recreate the object. However, J2EE, for example, can support stateful sessions, allowing the specific transaction to be clustered among multiple servers in a high-availability, real time system. Traditional customer relationship management solutions have only supported stateless transaction sessions.

Once availability systemic quality 154 is maintained in each of tiers 110 and in each of layers 130 in stage 515, exemplary subroutine 220 continues to stage 520 where scalability systemic quality 156 is maintained in each of tiers 110 and in each of layers 130. Scalability is useful in supporting unpredictable surges in demand for network services, especially in light of the Internet effect. J2EE, for example, does not require changes in the architecture or the loss of services during the time needed to scale. Thus if the customer relationship management solution is based on J2EE, it can run on any J2EE compliant application server, while supporting both vertical and horizontal scalability and session management.

From stage 520 where scalability systemic quality 156 is maintained in each of tiers 110 and in each of layers 130, exemplary subroutine 220 continues to stage 525 where reliability systemic quality 158 is maintained in each of tiers 110 and in each of layers 130. Due to the important services provided by customer relationship management architecture and their great expense, a reliable application is important. Applications built upon the standard APIs, such as those utilizing J2EE, are constantly tested, thus increasing reliability. For example, while a large vendor may implement 1000 deployments of a customer relationship management solution during the life of the solution (all with different versions and different proprietary API components), thousands of applications built around standard platforms, such as J2EE using standard APIs, are deployed each month.

After reliability systemic quality 158 is maintained in each of tiers 110 and in each of layers 130 in stage 525, exemplary subroutine 220 advances to stage 530 where manageability systemic quality 160 is maintained in each of tiers 110 and in each of layers 130. Customer relationship management operators require a clear and coherent management model that separates tier logic utilizing the best available component solutions to deliver customer relationship management solutions. While traditional customer relationship management solutions were often proprietary and constrained in functionality, standard platforms, such as J2EE, enables the utilization of the best available components and the integration of them into a comprehensive customer relationship management solution.

Once manageability systemic quality 160 is maintained in each of tiers 110 and in each of layers 130 in stage 530, exemplary subroutine 220 advances to stage 535 and returns to stage 225 of FIG. 2.

The examples of systemic qualities 150 that are maintained in each of tiers 110 and in each of layers 130 above are for illustrative purposes. Those skilled in the art will appreciate that may other types of systemic qualities 150 may be provided within customer relationship management architecture 100 and different systemic qualities 150 may be maintained in the each of tiers 110 and in each of layers 130 as described above.

In the preceding discussion of customer relationship management architecture 100, J2EE was identified as a standard platform consistent with implementing the invention and utilizable in embodiments consistent with the invention. Those skilled in the art will appreciate that standard platforms other than J2EE may be utilized.

In view of the foregoing, it will be appreciated that the present invention provides a customer relationship management architecture. Still, it should be understood that the foregoing relates only to the exemplary embodiments of the present invention, and that numerous changes may be made thereto without departing from the spirit and scope of the invention as defined by the following claims.

We claim:

1. A method for providing an integrated, enterprise-wide customer relationship management architecture, comprising:
separating services provided by the customer relationship management architecture into tiers; and
separating hardware and software that host services provided by the customer relationship management architecture into layers.

2. The method of claim 1, further comprising maintaining systemic qualities.

3. The method of claim 2, wherein the systemic qualities are maintained in each of the tiers and in each of the layers.

4. The method of claim 1, wherein the tiers comprises at least one of the following: a client services tier, a presentation services tier, a business services tier, an integration services tier, and a resources services tier.

5. The method of claim 4, wherein the client services tier resides on a client device and manages display and local interaction processing.

6. The method of claim 4, wherein the presentation services tier aggregates and personalizes content and services into channel-specific user interfaces.

7. The method of claim 4, wherein the business services tier executes business logic and manages transactions.

8. The method of claim 4, wherein the integration services tier abstracts and provides access to external resources.

9. The method of claim 4, wherein the resources services tier comprises at least one of the following: legacy systems, databases, external data feeds, and specialized hardware devices.

10. The method of claim 1, wherein the layers comprises at least one of the following: a hardware platform layer, a virtual platform layer, and an application layer.

11. The method of claim 10, wherein the hardware platform layer comprises standard computer hardware and an operating system for running the standard computer hardware.

12. The method of claim 10, wherein the virtual platform layer comprises standard application program interfaces (APIs) and specifications interfacing the hardware platform layer with the application layer.

13. The method of claim 10, wherein the application layer comprises application programs.

14. The method of claim 1, wherein the systemic qualities comprises at least one of the following: agility, availability, scalability, reliability, and manageability.

15. The method of claim 14, wherein the agility systemic quality is characterized by its ability to functionally accept at least one of the following: development without the aid of a software vendor, to be updated without the aid of a software vendor, and to be customized without the aid of a software vendor.

16. The method of claim 14, wherein the availability systemic quality at least comprises to ability to support stateful sessions.

17. The method of claim 14, wherein the scalability systemic quality at least comprises the ability to support unpredictable surges in demand for network services.

18. The method of claim 14, wherein the reliability systemic quality is characterized by its ability to functionally accept standard application program interfaces (APIs) that have been tested for reliability.

19. The method of claim 14, wherein the manageability systemic quality is characterized by its ability to functionally accept desirable hardware and software components and integrate them into the customer relationship management architecture.

20. An integrated, enterprise-wide customer relationship management architecture system, comprising:
tiers associated with services provided by the customer relationship management architecture;
layers associated with hardware and software that host services provided by the customer relationship management architecture;
systemic qualities which are maintained in each of the tiers and in each of the layers; and
wherein the tiers, layers, and systemic qualities have an orthogonal relationship.

21. The system of claim 20, wherein the orthogonal relationship comprises each of the systemic qualities being provided in at least one of the tiers, each of the tiers having different optimal choices of implementations in at least one of the layers; and each of the layers enabling different strategies associated with at least one of the tiers.

22. The system of claim 20, wherein the tiers comprise at least one of the following: a client services tier, a presentation services tier, a business services tier, an integration services tier, and a resources services tier.

23. The system of claim 20, wherein the layers comprise at least one of the following: a hardware platform layer, a virtual platform layer, and an application layer.

24. The method of claim 20, wherein the systemic qualities comprise at least one of the following: agility, availability, scalability, reliability, and manageability.

25. A method for providing an integrated, enterprise-wide customer relationship management architecture, comprising:
separating services provided by the customer relationship management architecture into tiers;
separating hardware and software that host services provided by the customer relationship management architecture into layers;
maintaining systemic qualities in each of the tiers and in each of the layers; and
relating the tiers, layers, and systemic qualities orthogonally wherein each of the systemic qualities being provided in at least one of the tiers, each of the tiers having different optimal choices of implementations in at least one of the layers, and each of the layers enabling different strategies associated with at least one of the tiers.
